(19) United States
(12) Patent Application Publication
(10) Pub. No.: US 2011/0138575 A1
(43) Pub. Date: Jun. 16, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/647,517

(22) Filed: Dec. 27, 2009

(30) Foreign Application Priority Data
Dec. 11, 2009 (CN) 200920317160.3

(51) Int. Cl. F16C 11/04; E05D 3/02; E05D 11/10; F16C 11/10

(52) U.S. Cl. 16/331

(57) ABSTRACT

A hinge includes a first leaf, a pivot shaft fixedly mounted to the first leaf, a second leaf rotatably mounted to the pivot shaft, a retention assembly mounted to the pivot shaft, a resilient assembly mounted to the pivot shaft; and two limiting members unrotatably mounted to the pivot shaft and located at opposite sides of the second leaf. Each limiting member forms two limiting surfaces at a circumference of the limiting member. The retention assembly defines a positioning column passing through the second leaf. The positioning column of the retention assembly is operable to engage with one of the limiting surfaces of each of the limiting members.

### BACKGROUND

1. Technical Field

The present disclosure relates to a hinge.

2. Description of Related Art

A foldable device, such as a notebook computer, or a foldable mobile phone, generally includes a base, and a cover pivotably mounted to the base via a hinge. The hinge generally includes a pivot shaft, a first leaf mounted to the pivot shaft, and a second leaf rotatably mounted to the pivot shaft. The first leaf is mounted to the base, and the second leaf is mounted to the cover, making the cover rotatable relative to the base. In a process of opening the foldable device, if the cover is opened too far, the hinge may be damaged, so the hinge generally includes a blocking mechanism to prevent this from happening. However, the blocking power of the blocking mechanism is often not enough to effectively prevent the hinge from being over rotated and thus damaged.

### BRIEF DESCRIPTION OF THE DRAWINGS

FIG. 1 is an exploded, isometric view of an exemplary embodiment of a hinge.

FIG. 2 is similar to FIG. 1, but viewed from another perspective.

FIG. 3 is an assembled, isometric view of the hinge of FIG. 2.

FIG. 4 is similar to FIG. 3, but showing a different state.

### DETAILED DESCRIPTION

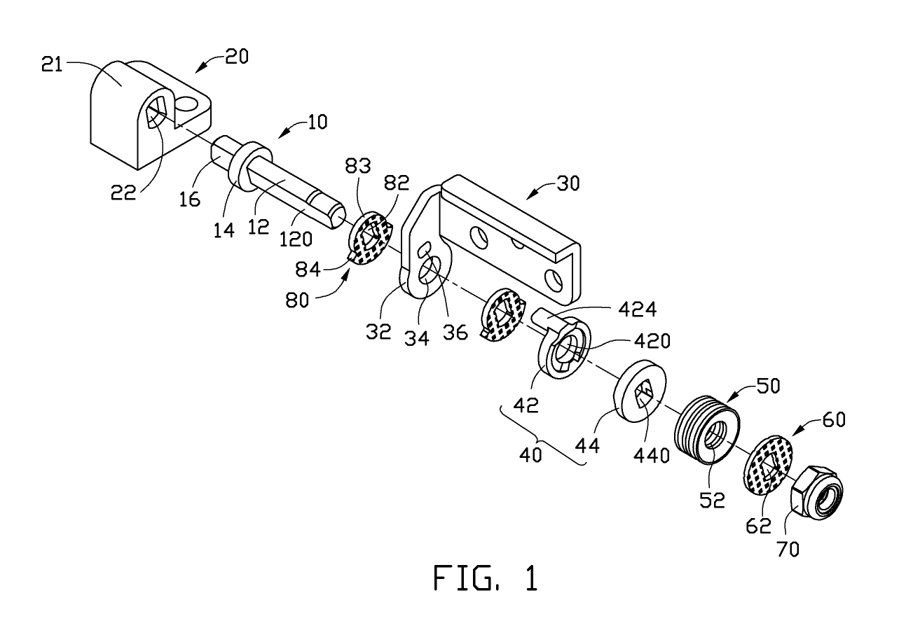

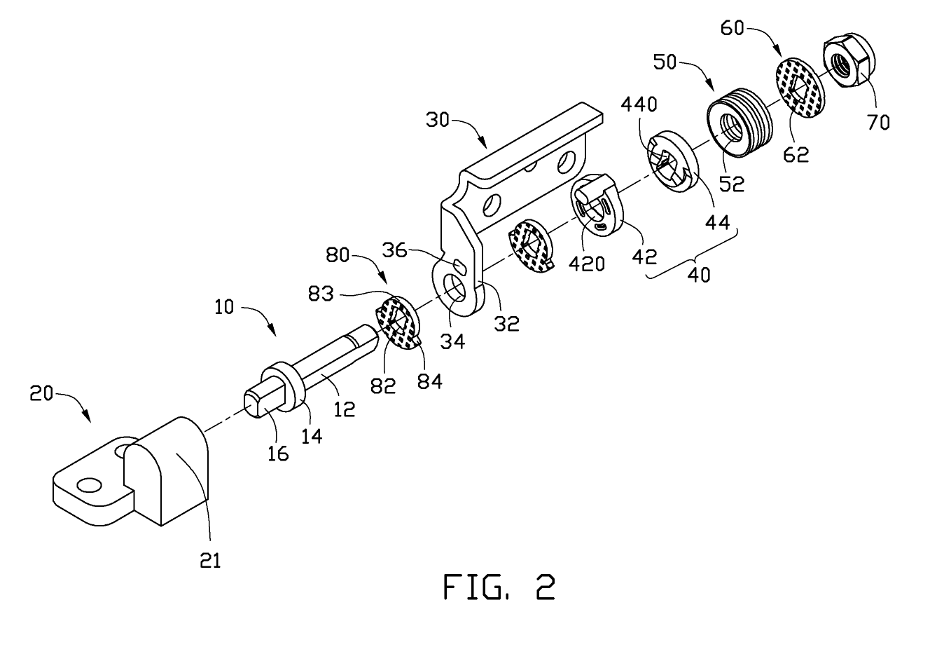

Referring to FIGS. 1 and 2, an exemplary embodiment of a hinge includes a pivot shaft 10, a first leaf 20, a second leaf 30, an retention assembly 40, a resilient assembly 50, a washer 60, a fastener 70, and two limiting members 80.

The pivot shaft 10 includes a rod 12 having a substantially non-circular cross-section. A first end of the rod 12 forms a threaded portion 120, and a second end of the rod 12 opposite to the first end forms a non-circular combination block 16. A cylindrical flange 14 extends between the rod 12 and the combination block 16.

The first leaf 20 is fixed to a base of a foldable device, such as a notebook computer, and includes a cylindrical combination portion 21. The combination portion 21 defines a non-circular receiving hole 22. The receiving hole 22 is corresponding to the combination block 16 of the pivot shaft 10.

The second leaf 30 is fixed to a cover of the foldable device and includes a combination portion 32. The combination portion 32 defines a round through hole 34 and a fixing hole 36 neighboring the through hole 34. The rod 12 of the pivot shaft 10 extends through the through hole 34.

The retention assembly 40 includes a first element 42, and a second element 44 engaging with and rotating relative to the first element 42.

The first element 42 is generally cylindrical and defines a round through hole 420 in a center. The rod 12 extends through the through hole 420. A positioning column 424 axially extends from a circumference of the first element 42, opposite to the second element 44.

The second element 44 is generally cylindrical and defines a non-circular through hole 440 in a center. The rod 12 of the pivot shaft 10 extends through the through hole 440.

The resilient assembly 50 includes a plurality of elastic elements stacked together. Each elastic elements defining a through hole 52 through which the rod 12 of the pivot shaft 10 extends.

The washer 60 defines a non-circular through hole 62 in a center of the washer 60, through which the rod 12 of the pivot shaft 10 extends.

In one embodiment, the fastener 70 is a screw nut.

Each limiting member 80 defines a non-circular through hole 82 in a center and an arc-shaped cutout 83 in a circumference of the limiting member 80. The rod 12 of the pivot shaft 10 extends through the through hole 82. Two ends of the cutout 83 respectively form a limiting surface 84.

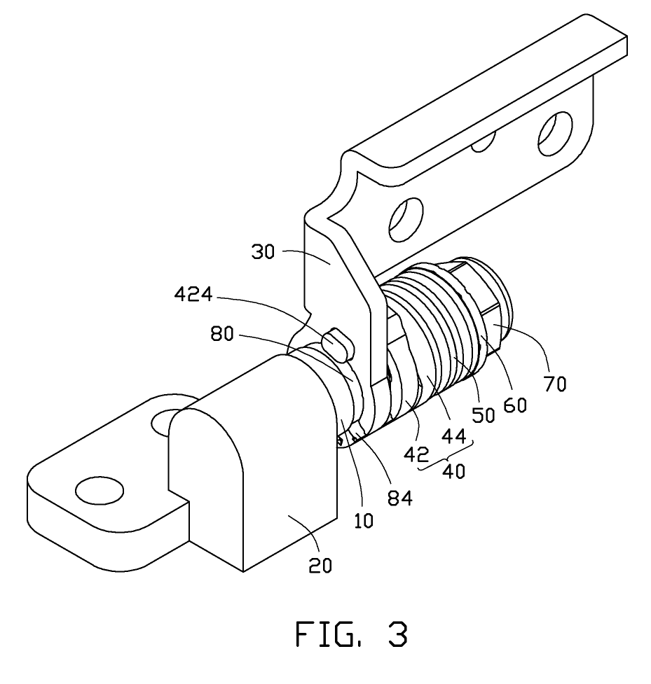

Referring to FIG. 3, during assembly, the combination block 16 is received and fixed in the receiving hole 22. One limiting member 80, the second leaf 30, the other limiting member 80, the first element 42, the second element 44, the plurality of elastic elements of the resilient assembly 50, the washer 60 is sleeved on the rod 12 in that order. The fastener 70 engages with the threaded portion 120, thus fixing the fastener 70 to the pivot shaft 10, to prevent the washer 60, the resilient assembly 50, the retention assembly 40, the limiting members 80, the second leaf 30 from disengaging from the pivot shaft 10. The flange 14 of the pivot shaft 10 is located between a corresponding limiting member 80 and the combination portion 21 of the first leaf 20. The positioning column 424 of the first element 42 engages in the fixing hole 36 of the second leaf 30, and is received in the cutouts 83 of the limiting members 80.

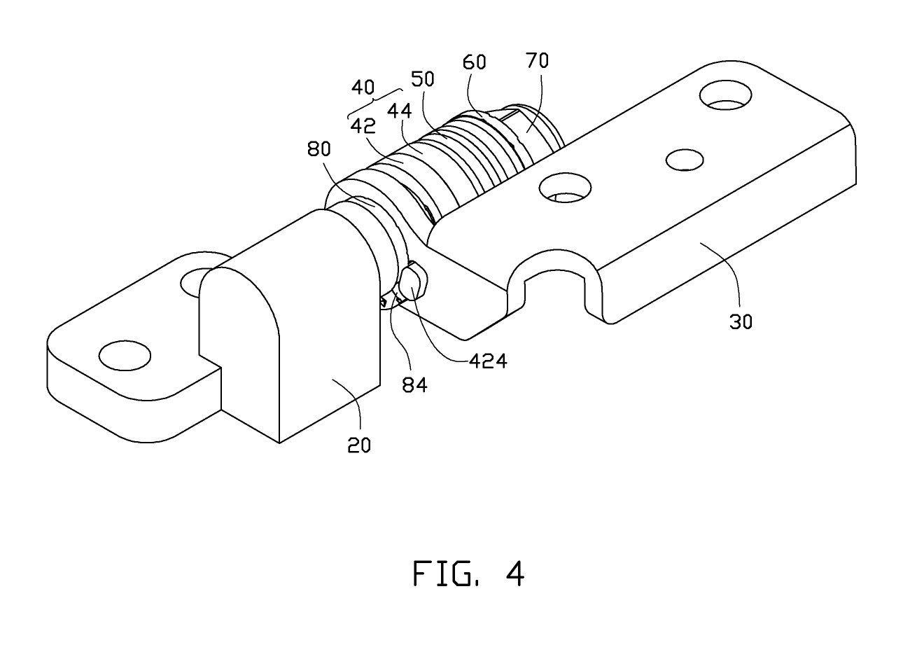

Referring to FIG. 4, in use, the second leaf 30 is rotated to drive the first element 42 synchronously to rotate relative to the pivot shaft 10. When the positioning column 424 engages with one of the limiting surfaces 84 of the limiting members 80, the limiting members 80 can block the second leaf 30 from further rotating.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A hinge comprising,
a first leaf;
a pivot shaft fixedly mounted to the first leaf;
a second leaf rotatably mounted to the pivot shaft;
a retention assembly mounted to the pivot shaft;
a resilient assembly mounted to the pivot shaft; and
two limiting members unrotatably mounted to the pivot shaft and located at opposite sides of the second leaf, wherein each limiting member forms two limiting surfaces at a circumference of the limiting member, and the retention assembly defines a positioning column passing through the second leaf, the positioning column of the retention assembly being operable to engage with one of the limiting surfaces of each of the limiting members.

2. The hinge of claim 1, wherein the pivot shaft comprises a rod having a substantially non-circular cross-section, a first end of the rod forms a threaded portion, a fastener is engaged with the threaded portion.

3. The hinge of claim 2, wherein a combination block extends from a second end of the rod, the first leaf comprises a combination portion defining a receiving hole to receive the combination block.

4. The hinge of claim 1, wherein the second leaf comprises a combination portion, the combination portion defines a through hole through which the pivot shaft extends, and a fixing hole neighboring the through hole through which the positioning column passes.

5. The hinge of claim 1, wherein the retention assembly comprises a first element, and a second element engaging and rotatable relative to the first element, the first element and the second each define a through hole through which the pivot shaft extends.

6. The hinge of claim 5, wherein the first element is generally cylindrical, the positioning column axially extends from a circumference of the first element.

7. The hinge of claim 1, wherein the resilient assembly comprises a plurality of elastic elements stacked together, and each of the plurality of elastic elements defines a through hole through which the pivot shaft passes.

8. The hinge of claim 2, further comprising a washer, wherein the washer is located between the resilient assembly and the fastener.

9. The hinge of claim 1, wherein each limiting member defines a through hole in a center through which the pivot shaft passes and an arc-shaped cutout in a circumference of the limiting member, two ends of the cutout respectively form the limiting surfaces.
